(19) United States
(12) Patent Application Publication
(10) Pub. No.: US 2007/0055009 A1
(43) Pub. Date: Mar. 8, 2007

(54) Pulverulent mixture comprising hydrogen peroxide and hydrophobized silicon dioxide

(75) Inventors: Steffen Hasenzahl, MORRIS PLAINS, NJ (US); Heike Riedemann, Mombris (DE); Egon Walzer, Maintal (DE); Friedhelm Brandner, Erlenbach (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, DUESSELDORF (DE)

(21) Appl. No.: 10/558,263

(22) PCT Filed: May 14, 2004
(86) PCT No.: PCT/EP04/05220

§ 371 Date: Nov. 21, 2005

(30) Foreign Application Priority Data
May 23, 2003 (DE) 103 23 840.9
Jan. 15, 2004 (DE) 10 2004 002 355.7

(51) Int. Cl. C08L 83/00; C08K 3/36; B32B 5/16

(52) U.S. Cl. 524/588; 524/492; 428/405

(57) ABSTRACT

Pulverulent mixture comprising hydrogen peroxide and hydrophobized, pyrogenically prepared silicon dioxide powder, wherein the hydrophobized silicon dioxide powder has a methanol wettability of at least 40 and is present to the extent of less than 9 wt. %, based on the total weight, and the content of hydrogen peroxide, based on the total weight, is between 10 and 50 wt. % It is prepared by a process in which hydrophobized silicon dioxide powder with a methanol wettability of more than 40 is treated with an aqueous hydrogen peroxide solution at temperatures of not more than 70° C. It can be used in detergents, in cleaning compositions and in skin and hair treatment compositions.

The invention provides a pulverulent mixture which comprises hydrogen peroxide and hydrophobized silicon dioxide, and the preparation and use thereof.

It is known from DE-A-2013763 to prepare pulverulent mixtures which comprise aqueous hydrogen peroxide solution and hydrophobized, pyrogenically prepared silicon dioxide. The content of hydrophobized silicon dioxide, based on the total weight of hydrogen peroxide solution and hydrophobized silicon dioxide, must be at least 9 wt. % in these mixtures.

To ensure an adequate flowability of the mixture, the content of hydrophobized 'silicon dioxide should preferably be between 10 and 35 wt. %. Hydrophobic silicon dioxides which are employed are those which have been hydrophobized with dimethyldichlorosilane or fatty alcohols having 8 to 26 carbon atoms.

A disadvantage of this mixture is the inadequate stability, of hydrogen-peroxide in the mixture with hydrophobic silicon dioxide. This is indeed described as good in DE-A-2013763 and can be increased further by known stabilizing agents for hydrogen peroxide. However, for many uses, such as, for example, as an additive to cleaning compositions, the necessary long-term stability does not exist. The relatively high content of hydrophobic silicon dioxide is a further disadvantage.

The object of the invention is to provide mixtures of silicon dioxide powder and hydrogen peroxide which have a long-term stability which is higher than that according to the prior art. On the basis of economic considerations, the mixtures should furthermore have the lowest possible content of silicon dioxide.

The object is achieved by a pulverulent mixture comprising hydrogen peroxide and hydrophobized, pyrogenically prepared silicon dioxide powder, which is characterized in that the hydrophobized silicon dioxide powder has a methanol wettability of at least 40 and is present in the mixture to the extent of less than 9 wt. %, based on the total weight, and the content of hydrogen peroxide, based on the, total weight, is between 10 and 50 wt. %

The methanol wettability represents the degree of hydrophobicity of the silicon dioxide powder. For this purpose, a certain amount of silicon dioxide powder is weighed into water. The silicon dioxide powder remains on the surface here. The concentration of methanol needed to wet the powder is now determined. The methanol wettability is the methanol content of a methanol-water mixture in % by volume at which 50% of the hydrophobized silicon dioxide sediments.

It has now been found that hydrophobized silicon dioxide powders with a methanol wettability of more than 40 lead to particularly storage-stable mixtures with hydrogen peroxide which have a hydrogen peroxide content of between 10 and 50 wt. %. Furthermore, a content of these hydrophobized silicon dioxide powders of less than 9 wt. %, based on the total mixture, already leads to the formation of a freely flowable powder.

The invention also provides a process for the preparation of the pulverulent mixture according to the invention, which is characterized in that hydrophobized silicon dioxide powder with a methanol wettability of more than 40 is treated with an aqueous hydrogen peroxide solution at temperatures of not more than 70° C.

Any mixing unit which adequately introduces energy into the system of hydrophobized silicon dioxide powder and aqueous hydrogen peroxide solution to ensure a rapid division of the liquid into small droplets, which are then immediately surrounded by hydrophobized silicon dioxide powder, is suitable for this purpose.

The hydrophobized silicon dioxide powders to be used are not limited, as long as they have a methanol wettability of at least 40. The silicon dioxide powders hydrophobized with octamethyloyclotetrasiloxane, polydimethylsiloxane, octylsilane and/or hexamethyldisilazane can preferably be employed.

The specific surface area of the hydrophobized silicon dioxide powders to be used also is not limited. Preferably, those with a specific surface area of between 10 and 400, and particularly preferably those of 80 to 300 m²/g can be employed.

Examples of such hydrophobized silicon dioxide powders are to be found in table 1.

TABLE 1
Hydxophobized silicon dioxide powders suitable for
the preparation of the powder mixture according to the
invention

| | | Spec. | |
|---|---|---|---|
| | | surface area | |
| Hydrophobized | Hydrophobizing | (approx.) | Methanol |
| SiO₂ | agent | m²/g | wettability |
| Aerosil ® | Octamethylcyclotetrasiloxane | 150 | 40 |
| R104 | | | |
| Aerosil ® | Octamethylcyclotetrasiloxane | 250 | 45 |
| R106 | | | |
| Aerosil ® | Polydimethylsiloxane | 100 | 70 |
| R202 | | | |
| Aerosil ® | Octylsilane | 150 | 45 |
| R805 | | | |
| Aerosil ® | Hexamethyldisilazane | 260 | 50 |
| R812 | | | |
| Aerosil ® | Hexamethyldisilazane | 220 | 60 |
| R812S | | | |
| Aerosil ® | Hexamethyldisilazane | 150 | 65 |
| R8200 | | | |

Hydrogen peroxide is employed as an aqueous solution, preferably with a content of hydrogen peroxide of between 5 and 70 wt. %. Solutions with an H₂O₂ content of 35 and 50 wt. % are usually employed.

The solutions are advantageously stabilized against decomposition. The nature and amount of the stabilizer or stabilizers primarily depends on the content of hydrogen peroxide in the aqueous solution.

It is also possible to-employ solutions which are not stabilized for the preparation of the powder mixture according to the invention. In these cases a lower stability of the powder must be expected. Suitable stabilizers are stannates, phosphates, pyrophosphates, nitrates, magnesium salts, phosphonic acid, aminophosphonic acids, EDTA, gelatine and mixtures thereof, which are added in amounts of between 0.01 and 1 wt. %.

The invention also provides the use of the powder mixture according to the invention in detergents, in cleaning compositions and in hair and skin treatment compositions.

The powder mixtures according to the invention can be used as a bleach component in detergents. Corresponding detergents are known to the expert from the prior art, with inorganic peroxygen compounds, such as, for example, sodium perborate or sodium carbonate perhydrate. In the use according to the invention in detergents and cleaning compositions, the inorganic peroxygen compounds are preferably replaced completely-or in part by the powder mixture according to the invention.

The powder mixtures according to the invention can be used as a bleach component or antiseptic component in cleaning compositions. Preferably, the powder mixtures according to the invention are used in cleaning compositions which are used for cleaning without the addition of water. Examples of such cleaning compositions are stain removers for textiles, upholstery, carpets and carpet flooring which are used without the addition of water, for example in powder form. In contrast to inorganic peroxygen compounds, such as, for example;,sodium perborate or sodium carbonate perhydrate, the powder mixtures according to the invention can also achieve their bleaching and antiseptic action in such cleaning compositions without the addition of water.

The powder mixtures according to the invention can be used as a bleach component in hair treatment compositions for bleaching hair. The powder mixtures according to the invention are preferably added to such hair-bleaching compositions in amounts of 20 to 80 wt. %. The hair-bleaching compositions moreover comprise at least one alkaline component, preferably chosen from hydroxides, carbonates, hydrogen carbonates and silicates of alkali metals or alkaline earth metals. The hair-bleaching composition preferably comprises the alkaline component in an amount of 10 to 40 wt. %. The hair-bleaching compositions preferably also comprise one or more surfactants, both nonionic and anionic, cationic or zwitter-ionic surfactants being suitable. The hair-bleaching compositions can furthermore comprise still further auxiliary substances, such as, for example, nonionic, anionic or cationic polymers, thickeners, protein hydrolysates, phospholipids, metal complexing agents, dyestuffs and perfume oils. Corresponding hair-bleaching compositions are known to the expert from the prior art, for example from WO 01/45658, with peroxodisulfates or other inorganic peroxides as a bleach component. In the use according to the invention in hair-bleaching compositions the peroxodisulfates are preferably replaced completely or in part by the powder mixture according to the invention.

The powder mixtures according to the invention can furthermore be used as an oxidizing agent in hair treatment compositions for permanent coloring of hair with oxidation dyestuffs. In this case, shortly before use of the hair-coloring composition the powder mixtures according to the invention are mixed with a formulation which comprises the precursors of developer component and coupling component for the oxidation dyestuff. In this context, the powder mixtures according to the invention can be mixed directly with the formulation of the dyestuff precursors or dispersed in an aqueous solution or emulsion beforehand. The formulation of the dyestuff precursors which is employed is preferably an aqueous emulsion which also comprises, in addition to a developer component and coupling component for the formation of the dyestuff, one or more emulsifiers, as well as one or more liquid non-polar components and optionally further auxiliary substances. Corresponding formulations of the dyestuff precursors are known to the expert from the prior art, for example from DE 199 01 886, for use with liquid hydrogen peroxide formulations. In the use according to the invention in hair-coloring compositions, the liquid hydrogen peroxide is preferably replaced completely or in part by the powder mixture according to the invention.

The powder mixtures according to the invention can furthermore be used as oxidizing agents in skin treatment compositions for cosmetic purposes, such as e.g. for brightening skin and for removing pigmental moles and freckles. Corresponding skin treatment compositions are known to the expert from the prior art, with inorganic peroxides, such as, for example, zinc peroxide or urea peroxide, organic peroxides, hydroquinone or basic bismuth salts as active compounds. In the use according to the invention in skin treatment compositions, the powder mixture according to the invention is used instead of these active compounds or in addition to one or more of these active compounds.

The powder mixture according to the invention can moreover be used for the preparation of compositions for disinfection of the skin and compositions for treatment of acne or psoriasis. Corresponding compositions for treatment of acne or psoriasis are known to the expert from the prior art, with organic peroxides, such as, for example, benzoyl peroxide, as active compounds. In the use according to the invention for the preparation of compositions for treatment of acne or psoriasis, the powder mixture according to the invention is used instead of the organic peroxide.

Finally, the powder mixture according to the invention can also be used as a hardener for curing formulations which can be cured by free radicals. Examples of such formulations which can be cured by free radicals are resins, lacquers and adhesives based on vinyl ester resins, unsaturated polyester resins or crosslinkable silicones. Corresponding formulations which can be cured by free radicals are known to the expert from the prior art, for curing with organic peroxides. In the use according to the invention for curing of formulations which can be cured by free radicals, the powder mixture according to the invention is used instead of an organic peroxide. The use of the powder mixtures according to the invention instead of organic peroxides has the advantage that the properties of the cured products are not adversely influenced by cleavage products of the organic peroxide, such as, for example, by evolution of odor or discoloration of the product.

### EXAMPLES

Analytical Methods

Determination of the Methanol Wettability:

In each case 0.2 g (±0.005 g) of hydrophobic silicon dioxide powder is weighed into transparent centrifuge tubes. 8. 0 ml. of a methanol/water mixture with in each case 10, 20, 30, 40, 50, 60, 70 and 80 vol. % methanol are added to each weighed portion. The closed tubes are shaken for 30 seconds and then centrifuged at 2,500 min⁻¹ for 5 minutes. The sediment volumes are read, converted into per cent and plotted against the methanol content (vol. %) on a graph. The point of inflection of the curve corresponds to the methanol wettability.

Determination of the Hydrogen Peroxide Content:

Hydrogen peroxide is reduced by iron(II) sulfate in sulfuric acid solution. The excess iron(II) sulfate is back-titrated with potassium permanganate solution. The titration is controlled by a Titroprocessor 682 with sample changer from Metrohm.

Procedure:

Approx. 0.6500-0.7000 g of a powder mixture of hydrogen peroxide and hydrophobized silicon dioxide is acidified with 25 ml 25 per cent sulfuric acid. 10 ml of an iron(II) sulfate solution (69.5 g/l iron(II) sulfate heptahydrate) are then pipetted in, and thereafter 50 ml of completely demineralized water are added. The mixture is mixed thoroughly with a propeller stirrer for 15 minutes and subsequently titrated with KMnO₄ solution (0.05 molar). The end point of the titration is determined potentiometrically. The consumption of KMnO₄ solution for the amount of iron(II) sulfate solution employed is called the blank value.

Calculation:

$$\frac{( blank value - consumption ) ml {KMnO}_{4} \cdot 42.52 \cdot 100}{weight ( g ) \cdot 1 \text{,} 000}$$

### Example 1

93 g of a 10 per cent hydrogen peroxide solution (stabilized in the conventional commercial manner) are mixed with 7 g Aerosil 812 S in a Multimixer (Braun, model MX 32) at the highest level for 45 seconds. The high shear forces of the mixer divide the liquid into small droplets, which are surrounded by the hydrophobic Aerosil. The mixture formed is a free-flowing powder.

Examples 2 to 4 were carried out analogously and give powders according to the invention.,

Examples 5 to 7 are comparison examples.

The starting materials and properties of powder mixtures with hydrogen peroxide and hydrophobized silicon dioxide are listed in table 2.

Examples 1 to 4 show that when a hydrophobized silicon dioxide powder with a methanol wettability of at least 40 is used, free-flowing powders with a high stability are obtained even with very low contents of 7 and 5 wt. %. Examples 6 and 7 show that when hydrophobized silicon dioxide powders with a methanol wettability of less than 40 are used, no free-flowing powder is obtained.

In example 5 a free-flowing powder is indeed obtained with a hydrophobized silicon dioxide powder with a methanol wettability of less than 40, but here also a lower stability of the hydrogen peroxide manifests itself.

TABLE 2
Starting materials and properties of powders comprising hydrogen
peroxide and hydrophobized silicon dioxide powder

| | | Example | | | | | | |
|---|---|---|---|---|---|---|---|---|
| | | 1 | 2 | 3 | 4 | 5 | 6 | 7 |
| Content of H₂O₂ in the solution | g | 93.0 | 93.0 | 93.0 | 95.0 | 91.0 | 91.0 | 85.0 |
| Conc. of H₂O₂ in the solution | wt. % | 10.0 | 35.0 | 50.0 | 10.0 | 10.0 | 10.0 | 10.0 |
| Hydrophobized | | R812S | R812S | R812S | R202 | R972 | R972 | R816 |
| Aerosil | | | | | | | | |
| Content of hydrophobized | g | 7.0 | 7.0 | 7.0 | 5.0 | 9.0 | 7.0 | 15.0 |
| Aerosil | | | | | | | | |
| Methanol | | 60 | 60 | 60 | 70 | 35 | 35 | 0 |
| wettability | | | | | | | | |
| Content of H₂O₂ in the powder | | | | | | | | |
| after 0 days | wt. % | 10.1 | 35.1 | 50.1 | 10.07 | 35.1 | n.a. | n.a. |
| after 30 days | | 10.05 | 34.95 | 45.6 | 9.98 | 29.2 | | |
| after 60 days | | 9.5 | 34.8 | 40.5 | 9.37 | 23.8 | | |

* n.a. = no flowable powder;

### Examples 8 and 9

Use in a hair treatment composition for bleaching hair.

TABLE 3
Composition of the hair-bleaching powders and the
associated hydrogen peroxide developer solutions in wt. %

| | | Example 9 |
|---|---|---|
| | | (comparison |
| Constituents | Example 8 | example) |
| Hair-bleaching powder | | |
| Ammonium peroxodisulfate | — | 30.0 |
| Potassium peroxodisulfate | — | 30.0 |
| Product from example 3 | 38.8 | — |
| Sodium metasilicate | 27.6 | 18.0 |
| Sodium stearate | 15.3 | 10.0 |
| Magnesium carbonate | 12.2 | 8.0 |
| Protein hydrolysate | 1.5 | 1.0 |
| Sodium carboxymethylcellulose | 3.8 | 2.5 |
| Ethylenediaminetetraacetic | 0.8 | 0.5 |
| acid, disodium salt | | |
| Developer solution | | |
| Hydrogen peroxide, 50 wt. % | 24.00 | 24.00 |
| Phosphoric acid, 85 wt. % | 0.50 | 0.50 |
| Acetanilide | 0.01 | 0.01 |
| Water | 75.49 | 75.49 |

The constituents of the hair-bleaching powder were weighed into a 1,000 ml glass vessel in the ratio of amounts shown in table 3 (total batch: 500 g). After the glass vessel had been closed, the components were mixed gently in a free-fall mixer (Turbula, Bachofen) at 42 rpm for 10 min. The developer solution (total amount also 500 g) was prepared by initially introducing water into a cleaned glass vessel and adding hydrogen peroxide, phosphoric acid and acetanilide in the ratios of amount of table 3, while stirring with a glass rod.

The hair-bleaching powder and developer were mixed in a ratio of 1:1. In each case 2.0 g of this mixture were applied to 0.5 g of hanks of dark blond hair (Fischbach+Miller, code 6923). After an action time of 30 min the mixture was rinsed out of the hanks of hair and the hair was dried in a drying cabinet at 40° C. for 2 h and then evaluated visually. The hair bleached with the mixture from example 8 was significantly lighter than that treated with the mixture from comparison example 9.

### Examples 10 and 11

Use in a hair treatment composition for coloring hair.

To prepare the coloring cream, 395.00 g of deionized water and 35.0 g of aqueous 25 wt. % ammonia solution were initially introduced into a 3 1 Stephan mixer (Stephan UMC 5 electronic, A. Stephan und Söhne GmbH & Co., Hameln, Germany). All further constituents were added and mixed in slowly in the ratios of amounts of table 4. The mixture was then homogenized for 10 min at 1,000 rpm, so that a uniform cream was formed, which was then transferred to a thoroughly cleaned 1 1 glass bottle with a screw cap. To prepare the developer emulsion, 442.5 g of water were initially introduced into the cleaned Stephan mixer and all further components were added in the ratios of amounts of table 4, with slow stirring. This mixture was then mixed at 50 rpm for 15 min until a homogeneous, slightly viscous mass had formed. This was in turn transferred to a thoroughly cleaned 1 1 glass bottle with a screw cap.

The coloring cream and developer emulsion were mixed in a ratio of 1:1 directly before use. In each case 2.0 g of this. mixture were applied to 0.5 g of hanks of dark blond hair (Fischbach+Miller, code 6923). After an action time of 25 min the mixture was rinsed out and the hair was dried in a drying cabinet at 40° C. for 2 h and then evaluated visually. Both mixture lead to a light copper shade, the mixture from example 10 leading to a stronger colour shade. Furthermore, it was significantly more viscous and, therefore easier to apply that that from comparison example 11.

TABLE 4
Composition of the colouring cream and the
associated developer emulsion in wt. %

| | | Example 11 |
|---|---|---|
| | | (comparison |
| Constituents | Example 10 | example) |
| Colouring cream | | |
| C₁₂-C₁₈-Fatty alcohol mixture | 7.00 | 7.00 |
| Lanolin | 1.50 | 1.50 |
| C₁₂₋₁₈-Fatty alcohols • 20 EO | 1.50 | 1.50 |
| Lanolin alcohol • 5 EO | 1.00 | 1.00 |
| Cationic polymer | 1.00 | 1.00 |
| Ammonium sulfate | 0.50 | 0.50 |
| Sodium sulfite | 0.50 | 0.50 |
| Ethylenediaminetetraacetic | 0.10 | 0.10 |
| acid, disodium salt | | |
| 2,4-Diaminophenol | 0.30 | 0.30 |
| dihydrochloride | | |
| 5-Amino-2-methylphenol | 0.21 | 0.21 |
| 2,5-Diaminotoluene sulfate | 0.07 | 0.07 |
| Resorcinol | 0.04 | 0.04 |
| Ammonia, 25 wt. % | 7.00 | 7.00 |
| Perfume oil | 0.30 | 0.30 |
| Water | 78.98 | 78.98 |
| Developer emulsion | | |
| Hexadecyl alcohol | 3.00 | 3.00 |
| C_{12/18}-Fatty alcohol • 20 EO | 1.00 | 1.00 |
| C_{16/18}-Fatty alcohol sulfate | 1.00 | 1.00 |
| Hydrogen peroxide, 50 wt. % | — | 6.00 |
| Product from example 4 | 6.45 | — |
| Phosphoric acid, 85 wt. % | 0.50 | 0.50 |
| Acetanilide | 0.01 | 0.01 |
| Water | 88.04 | 88.49 |

### Examples 12 and 13

Use in skin treatment compositions for cosmetic treatment of acne.

To prepare the acne gel from example 12, ethanol was initially introduced into a Stephan mixer. The other components were added in the ratio of amounts stated in table 5, with slow-stirring (total batch: 500 g) and the mixture was then homogenized gently at 50 rpm for 15 min.

TABLE 5
Composition of a gel-like skin treatment
composition in wt. %

| Constituents | Example 12 |
|---|---|
| Product from example 3 | 3.69 |
| Ethanol | 91.31 |
| Veegum | 0.5 |
| Macrogol lauryl ether | 2.5 |
| Hypromellose | 2.0 |

The acne cream of example 13 was prepared by adding to the lipophilic cream base (Deutscher Arzneimittelkodex, Neues Rezeptur-Formularium 1999 [German-Pharmaceuticals Codex, New Recipe Formularium 1999], supplement 16, NRF 11.104,Govi-Verlag, Deutscher Apotheker-Verlag), which had been initially introduced into a Stephan mixer, all further components in the ratios of amounts stated in table 6, with slow stirring (total batch: 500 g) and the resulting mixture was then homogenized gently at 50 rpm for 15 min.

TABLE 6
Composition of a skin treatment composition in the
form of a cream in wt. %

| Constituents | Example 13 |
|---|---|
| Product from example 4 | 7.56 |
| O/W Ointment base | 87.34 |
| Triton X-200 | 1.0 |
| Sodium lauryl sulfoacetate | 2.0 |
| Sodium dihexyl sulfosuccinate | 2.0 |
| Imide-urea | 0.1 |

### Example 14

Use in a powdered detergent.

TABLE 7
Composition of a powdered detergent in wt. %

| Constituents | Example 14 |
|---|---|
| Product from example 2 | 12.0 |
| Linear alkylsulfonate | 10.0 |
| Ethoxylated fatty alcohols | 5.3 |
| Sodium soap | 3.7 |
| Defoamer | 4.4 |
| Zeolite | 32.3 |
| Sodium carbonate | 13.2 |
| Copolymer | 2.7 |
| Sodium silicate | 3.5 |
| Carboxymethylcellulose | 1.5 |
| Phosphonic acid | 3.5 |
| Optical brightener | 0.2 |
| Sodium sulfate | 7.3 |
| Protease | 0.5 |

### Example 15

Use for curing an unsaturated polyester resin.

1.7 parts by weight of pyrogenic silica.(AEROSIL 200) are added to 62 parts by weight of Palatal A 410-01 (unsaturated polyester resin). 18 parts by weight of styrene are then added. Thereafter, 0.5 part by weight of BYK-A 555 are mixed in as a de-aerating additive. Finally, for crosslinking, 1 part by weight of the powder mixture according to the invention from example 2 is added. Thereafter, the mixture cures completely, without discoloration.

1. A pulverulent mixture comprising hydrogen peroxide and hydrophobized, pyrogenically prepared silicon dioxide powder, wherein the hydrophobized silicon dioxide powder has a methanol wettability of at least 40 and is present to the extent of less than 9 wt. %, based on the total weight, and the content of hydrogen peroxide, based on the total weight, is between 10 and 50 wt. %

2. The process for the preparation of the pulverulent mixture according to claim 1, wherein the hydrophobized, pyrogenically prepared silicon dioxide powder with a methanol wettability of at least 40 is treated with an aqueous hydrogen peroxide solution at temperatures of not more than 70° C.

3. The process according to claim 2, wherein a silicon dioxide powder hydrophobized with octamethylcyclotetrasiloxane, polydimethylsiloxane, octylsilane and/or hexamethyldisilazane is employed as the hydrophobized, pyrogenically prepared silicon dioxide powder.

4. The process according to claim 3, wherein the specific surface area of the silicon dioxide powder is between 90 and 400 m²/g.

5. The process according to claim 2, wherein the aqueous hydrogen peroxide solution has a content of hydrogen peroxide of between 5 and 70 wt. %.

6. The process according to claim 5, wherein the aqueous hydrogen peroxide solution is stabilized.

7. (canceled)

8. A method for the preparation of compositions for treatment of acne comprising adding the pulverulent mixture as claimed in claim 1 to an acne treatment formulation.

9. (canceled)

10. A detergent comprising the pulverulent mixture as claimed in claim 1.

11. A cleaning composition comprising the pulverulent mixture as claimed in claim 1.

12. A skin treatment composition comprising the pulverulent mixture as claimed in claim 1.

13. A hair treatment composition comprising the pulverulent mixture as claimed in claim 1.

14. A hardener for a curing formulation comprising the pulverulent mixture as claimed in claim 1.

15. The hardener as claimed in claim 14 wherein the curing formulation is a vinyl ester resin, an unsaturated polyester resin or a crosslinkable silicone.

16. A method for hardening a curing composition comprising adding the pulverulent mixture as claimed in claim 1 to a curing composition then curing the composition.
